(19) United States
(12) Patent Application Publication
(10) Pub. No.: US 2021/0312338 A1
(43) Pub. Date: Oct. 7, 2021

(54) TRANSIT LOCATION SYSTEM

(71) Applicant: Uber Technologies, Inc., San Francisco, CA (US)

(72) Inventors: Donald Stayner, San Francisco, CA (US); Justin Angel, San Francisco, CA (US); Hemabh Shekhar, San Francisco, CA (US); Jake Hurley, San Francisco, CA (US)

(21) Appl. No.: 16/840,078

(22) Filed: Apr. 3, 2020

(51) Int. Cl. G06Q 10/02; G06Q 10/06; H04W 4/021; H04W 4/029; H04W 4/42; G06Q 50/30

(52) U.S. Cl. CPC G06Q 10/02; G06Q 10/06314; G06Q 50/30; H04W 4/029; H04W 4/42; H04W 4/021

(57) ABSTRACT

A network system receives a transport request from a user device for a route from a first location to a destination, the route including at least a first leg to an intermediate location using a first type of transportation and a second leg from the intermediate location to the destination using a second type of transportation. The network system receives transit data associated with the first type of transportation, and determines, based on a location of the user device and the transit data, that a user of the user device is following the route. The network system schedules, at a time determined based on the location of the user device, a provider to transport the user along the second leg of the route.

### BACKGROUND

A computing system can implement on-demand transport services in which a user's location underground is identified and used to trigger various service-related functions to improve the operation of the computing system.

### BRIEF DESCRIPTION OF THE DRAWINGS

FIG. 1 illustrates an example transit location system, in accordance with some aspects.

FIG. 2 is a block diagram illustrating an example computing device executing an application for communicating with a network computer system, according to examples described herein.

FIG. 3 illustrates an example method for a network computer system to interact with a user device in the context of a transit location system.

FIG. 4 illustrates an example method for a user's mobile computing device to request transport from the transit location system.

FIG. 5 illustrates an example method for a user device to determine its location in the context of an example transit location system.

FIG. 6 is a simplified map depicting transit stations as part of a use case example.

FIG. 7 is a block diagram that illustrates a computer system upon which aspects described herein may be implemented.

### DETAILED DESCRIPTION

In current on-demand transport applications, users can request routes from a starting location to a destination and receive a list of options. The user can select one of the route options and view instructions showing when and where to catch various methods of transit (e.g., trains, buses) to reach the destination. The system can then periodically determine the location of the user's device through methods such as GPS and cellular triangulation to provide updates and information to the user. However, these methods are only effective above ground. On a subway or underground train with unreliable cellular coverage or internet connectivity, current systems cannot determine the user's location or verify whether the user is following the selected route. Therefore, conventional systems cannot provide updates and information to the user in underground use cases.

In order to solve this problem, a transit location system can store a database of locations of underground beacons, including WiFi routers and Bluetooth Low Energy transmitters, that a user device can correlate with transit data (e.g., train schedules, bus schedules, real-time train locations, etc.) to determine whether the user is following a selected route, where the user is on that route, and when the user should arrive at certain points along the route.

In some aspects, a user's computing device can attempt to determine its location through the device operating system's location feature, which may utilize GPS and/or cellular connectivity. If the operating system cannot determine the user's location accurately, which is often the case when the user is underground, the computing device can scan for WiFi routers and BLE beacons to use for localization. For any detected WiFi routers or BLE beacons, the device can cross-reference the MAC address and/or Service ID of the device with the database of beacon locations. If a match is found, the user device can determine that its location is near the location of the matching beacon.

In further aspects, the user's computing device can use inertial sensors on the device, such as an accelerometer, to detect that the user is on a train, when the train arrives and leaves a station, and how many stations the user has passed through on the train. These calculations can be used to compare the selected route to transit routes in a database of transit data in order to determine the location of the user device and whether the user is following the selected route. In addition, any previously determined locations of the user device can assist in determining where the user is along the route when cross-referenced with the transit data.

Based on a comparison of the selected route with the determined location, any previously-determined locations, and transit data, the transit location system can determine whether the user is following the selected route, where the user is on that route, and when the user should arrive at certain points along the route. The transit location system can then use that information to trigger various service-related functions to improve the user experience and the overall operation of the on-demand transport system. Among other benefits, the transit location system can improve the efficiency of matching algorithms between riders and drivers by pushing up the request time using the enhanced location-determination functionality provided by the transit location system.

In some examples, the transit location system can provide guided navigation to the user, including push notifications to inform the user when to get on or off a train as part of the selected route. In other examples, the transit location system can provide information to the user about any delays or transit congestion along the selected route.

In multimodal transit scenarios, the transit location system can schedule the next mode of transportation for the user at an appropriate time based on estimated times of arrival. For example, if the system determines that the user is on a train which should arrive soon at Station D and the next leg of the user's selected multimodal route involves taking a rideshare vehicle from Station D, the system can automatically transmit a transit request to a rideshare server to solicit a vehicle to take the user from Station D to the next point on the user's route.

One or more aspects described herein provide that methods, techniques and actions performed by a computing device are performed programmatically, or as a computer-implemented method. Programmatically means through the use of code, or computer-executable instructions. A programmatically performed step may or may not be automatic.

One or more aspects described herein may be implemented using programmatic modules or components. A programmatic module or component may include a program, a subroutine, a portion of a program, a software component, or a hardware component capable of performing one or more stated tasks or functions. In addition, a module or component can exist on a hardware component independently of other modules or components. Alternatively, a module or component can be a shared element or process of other modules, programs or machines.

Furthermore, one or more aspects described herein may be implemented through the use of instructions that are executable by one or more processors. These instructions may be carried on a computer-readable medium. Machines shown or described with figures below provide examples of processing resources and computer-readable media on which instructions for implementing some aspects can be carried and/or executed. In particular, the numerous machines shown in some examples include processor(s) and various forms of memory for holding data and instructions. Examples of computer-readable media include permanent memory storage devices, such as hard drives on personal computers or servers. Other examples of computer storage media include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable media.

Alternatively, one or more examples described herein may be implemented through the use of dedicated hardware logic circuits that are comprised of an interconnection of logic gates. Such circuits are typically designed using a hardware description language (HDL), such as Verilog and VHDL. These languages contain instructions that ultimately define the layout of the circuit. However, once the circuit is fabricated, there are no instructions. All the processing is performed by interconnected gates.

System Overview

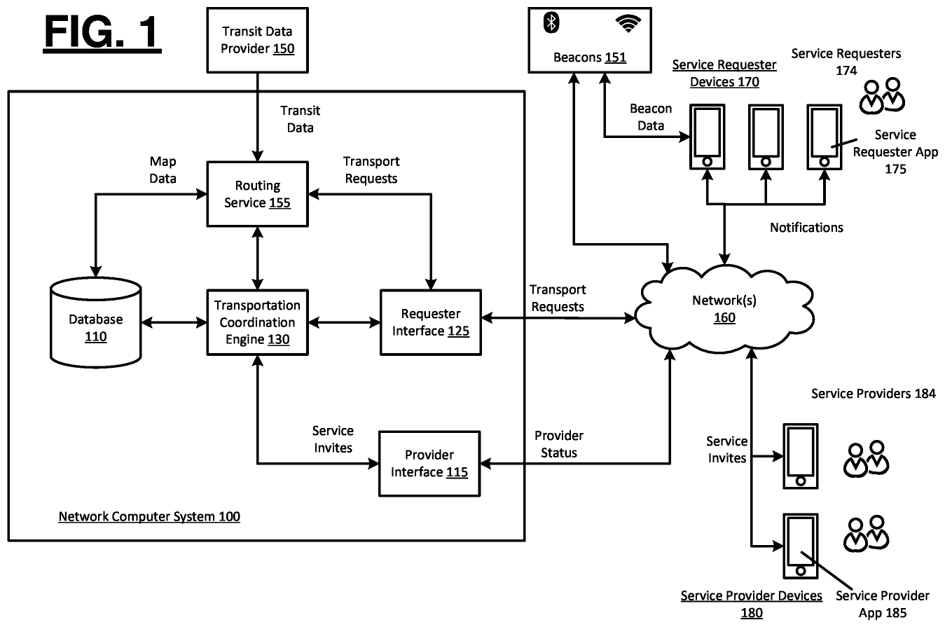

FIG. 1 illustrates an example transit location system, in accordance with some aspects. The network computer system 100 can implement or manage the transit location system as part of a network service (e.g., an on-demand transport or delivery arrangement service) that connects service requesters 174 with service providers 184 that are available to fulfill transport requests that service requesters 174 transmit to the network computer system 100. The network service can enable services to be requested by service requesters 174 and provided by available service providers 184 by way of a service requester application 175 executing on the service requester devices 170, and a service provider application 185 executing on the service provider devices 180. As used herein, service requester devices 170 and service provider devices 180 can comprise computing devices with functionality to execute designated applications corresponding to the on-demand arrangement service managed by the network computer system 100. In many examples, service requester devices 170 and service provider devices 180 are mobile computing devices, such as smartphones, tablet computers, virtual reality or augmented reality headsets, on-board computing systems of vehicles, and the like. Example network services include delivery of food or products, package mailing, shopping, construction, plumbing, home repair, housing or apartment sharing, as well as transportation arrangement services.

The network computer system 100 can include a provider interface 115 to communicate over one or more networks 160 with the service provider application 185 running on service provider devices 180. According to examples, service providers 184 register with the network computer system 100 to receive service invitations through the service provider application 185 to fulfill service requests (e.g., transport requests) submitted by the service requesters 174. In an example using transport services, the service requesters 174 are prospective passengers who want to travel to a destination, and the service providers 184 are drivers of personal vehicles who transport the service requesters 174 to their destinations or to points closer to their destinations.

In accordance with various examples, the service provider device 180 transmits a provider status, which can include any selected modes, the current location of the service provider 184, and other provider information, over the network 160 to the provider interface 115. In some implementations, the service provider devices 180 can determine the current location of the service provider 184 using location-based resources of the service provider devices 180 (e.g., global positioning system (GPS) resources). The service provider application 185 can continually update the provider status on a regular schedule or in response to provider input to the service provider device 180, location changes determined by GPS, service steps performed, etc. The network computer system 100 stores the provider status in a database 110 accessible by a transportation coordination engine 130 that processes service requests in order to select service providers 184 to fulfill the service requests.

The network computer system 100 can include a requester interface 125 to communicate with service requester devices 170 over one or more networks 160 via a service requester application 175. According to examples, a service requester 174 can launch the service requester application 175 to utilize the on-demand arrangement service and transmit a service request over the network 160 to the network computer system 100. In certain implementations, the service requester 174 can view multiple different service types managed by the network computer system 100, such as ride-pooling, a basic ride-share service type, a luxury vehicle service type, a van or large vehicle service type, professional services (e.g., where the service provider is certified), an on-demand self-driving vehicle service, and the like. The service requester application 175 can also combine multiple service types to create multileg and multimodal service options, such as an option that facilitates the service requester 174 in taking a public transit option to an intermediate location where the service requester 174 can take a ride-share vehicle to a final destination.

The network computer system 100 can utilize service provider locations to provide the service requester devices 170 with estimated time to arrival (ETA) data of proximate service providers 184 for each respective service. In one implementation, the service requester application 175 can enable the service requester 174 to scroll through each service type. In response to a soft selection of a particular service type, the network computer system 100 can provide ETA data on a user interface of the service requester application 175 that indicates an ETA of the closest service provider 184 for the service type and/or the locations of all proximate available service providers 184 for that service type. As the service requester 174 scrolls through each service type, the user interface can update to show visual representations of the service providers 184 for that service type on a map centered on the service requester 174 or a chosen service start location. For transit and multimodal service options, the user interface can display locations of transit stations and transit vehicles as well as schedules for those stations and vehicles. The service requester 174 can interact with the user interface of the service requester application 175 to select a particular service type or types and request one or more route options to a destination using that particular service type or types. The service requester application 175 can additionally enable the service requester 174 to transmit a service request corresponding to one of the route options to the network computer system 100 to schedule any service providers 184 or other means to transport the service requester 175 along one or more legs of the selected route.

In some examples, the service request can include a service start location within a given region (e.g., a metropolitan area managed by one or more datacenters corresponding to the network computer system 100) where a matched service provider 184 is to rendezvous with the service requester 174. The service requester 174 can input the service start location by setting a location pin on a user interface of the service requester application 175, or the service start location can be determined by a current location of the service requester 174 (e.g., utilizing location-based resources of the service requester device 170). Additionally, the service requester 174 can input a service destination during or after submitting the service request. In an example using transport services, the service requester 174 is a prospective passenger who wants to travel from the service start location to the destination. In multimodal examples, the route can be divided into multiple legs, such as a first leg to an intermediate location using a first type of transportation and a second leg from the intermediate location to the destination using a second type of transportation.

Location data corresponding to the service requester device 170, start location, and destination can be latitude and longitude coordinates determined by a single method or combination of methods, including the use of global navigation satellite system units, cellular triangulation, and WiFi location techniques, among others. In other aspects, the network computer system 100 can determine the geographic locations of service requesters 174 and service providers 184 based on data received from the service requester devices 170 and service provider devices 180 that indicates the relative location of a specific device to another. For example, a device can detect other nearby devices using frequency identification (RFID), near field communication (NFC), and/or Bluetooth. The device can send data corresponding to these other devices to the network computer system 100, which can use the data in combination with other data (e.g., coordinates of the detected nearby devices or other devices) to determine the geographic location of the device in question. Alternatively or in addition, the device can use technologies like RFID, NFC, and Bluetooth to determine distance to other devices without a global reference frame.

In some aspects, the network computer system 100 can include a routing service 155 to generate route options for a user to travel from a starting location to a destination. A service requester 174 can transmit, via the service requester application 175, a request for a route from the starting location to the destination, and the routing service 155 can determine whether the request should be serviced as a single-leg or a multileg trip, which can include one or more transit vehicles. In contrast to a single-leg request, a multileg request can partition the distance between the starting location and destination into multiple routes, or legs, between transfer locations, with the first leg beginning at the starting location and the last leg ending at the destination. In one example, the multileg routing service compares estimates of the costs (to the user, providers, and/or the transport service) of a single-leg trip and a number of possible multileg trips. In one implementation, the multileg routing service can present multiple trip options and their costs to the user through the service requester application so that the user can select a preferred option.

The routing service 155 can receive transit data provided by one or more transit data providers 150 that operate or monitor third-party transit means, such as trains, buses, flights, boat ferries, and the like. The transit data can include static data, including established schedules, station information, routes, etc. as well as real-time data such as delays, construction information, detours, cancelations, etc. The routing service 155 can use the transit data in order to create routes between locations in transport requests received from users. The routing service 155 can also use the transit data to determine whether a given service requester 174 is following the route by, for example, comparing the geographic location over time of the service requester device 170 with schedules and locations of transit vehicles that the service requester 174 is expected to use when following the route.

Once a multileg route is generated, the routing service 155 can transmit, through the requester interface 125, data corresponding to the route legs for the multileg route back to the service requester 174. These data are displayed to the requester on a user interface of the service requester application 175 and can show information to the requester such as where each leg starts and ends, estimated travel and wait times for each leg, and the cost to fulfill the service request. In some aspects, the requester can accept one of the multileg route options, or the requester can change one or more details, such as the number of legs desired or the destination, and submit another request.

In some aspects, the network computer system 100 can include a transportation coordination engine 130 to select an optimal service provider to fulfill one or more legs for the route corresponding to the service request. The transportation coordination engine 130 can arrange for a separate service provider 184 to provide service along any of the legs that use a ride-share vehicle, with each service provider 184 being chosen as the user approaches the next transfer location. The transportation coordination engine 130 can retrieve service provider locations and requester locations from the database 110 to select optimal service providers, who may be closest to the service requester 174 with respect to distance or time, or can be a proximate provider that is optimal for other reasons, such as the provider's experience, the amount of time the provider has been on the clock, and the like.

In one aspect, the routing service 155 can periodically receive location updates from the service requester device 170 when the device has available network connectivity. From the location updates, the routing service 155 can determine whether the service requester 174 is following the selected route. For example, the routing service 155 can periodically estimate a duration of travel time between the last known location of the service requester 174 and a waypoint (such as an intermediate location where the next leg of the route begins), and the routing service 155 can determine that the service requester 174 is following the selected route when the estimated duration of travel time is decreasing. In another example, the route can include various checkpoints, such as transit stations, and the routing service 155 can determine that the service requester 174 is following the route when the location of the service requester device 170 is found to be near (e.g., within a geofence) of a threshold number of the checkpoints within a period of time corresponding to the route data.

In order for the service requester device 170 to determine its location when underground or in other areas where cellular, GPS, and other location-determination methods are unavailable or unreliable, a transit location system can include beacons 151. The beacons 151 can have known locations in places such as transit stations that the service requester application 175 can use to estimate its geographic location. The beacons 151 can be hardware transmitters that broadcast an identifier to nearby portable electronic devices, such as the service requester devices 170. The beacons 151 can communicate directly with service requester devices 170 over one or more wireless protocol families, including Bluetooth Low Energy (BLE), near field communication (NFC), IEEE 802.11, etc. The identifier can be used to determine an approximate physical location of the service requester device 170 and trigger a location-based action on the device such as a push notification or an automatic transport request for the next leg of the selected route. For example, if the service requester application 175 detects a beacon 151 with a location matching a train station where the service requester 174 should get off a train as part of the selected route, the service requester application 175 can generate a notification on the user interface of the service requester device 170.

The transit location system can include beacons 151 that are one-way transmitters, such as BLE beacons, and also two-way transmitters/receivers, such as WiFi routers. In one aspect, the service requester application 175 includes a database of locations of known beacons 151. Therefore, when the service requester device 170 receives a broadcasted identifier from a beacon 151, the service requester application 175 can lookup the identifier in the database to determine the physical location of the beacon 151 and estimate the location of the service requester device 170. In other aspects, some beacons 151 can store their locations and be programmed to broadcast their location to any nearby service requester devices 170 or to respond to a location request from a service requester device 170.

In other aspects, the service requester application 175 can transmit information identifying the service requester 174 (e.g., an account identifier, device ID, etc.) to one or more of the beacons 151 when the service requester device 170 is in range. The beacons 151 can then transmit the identifying information to the network computer system 100 so that the routing service 155 can determine whether the service requester 174 is following the route even if the service requester application 175 fails to report its location to the network computer system 100, which may occur underground or in other locations where the service requester device 170 does not have internet connectivity.

In some aspects, as the service requester 174 approaches a transfer location for a leg of a multileg route, the transportation coordination engine 130 arranges for a provider for the next leg to rendezvous with the service requester 174 at the transfer location. In some aspects, once the service requester 174 is within a threshold amount of time to the transfer location (e.g., 5 minutes, 10 minutes, etc.), the transportation coordination engine 130 selects a provider with an ETA to the transfer location that is similar to the threshold amount of time in order to minimize the amount of time that the service requester 174 and the provider have to wait for the other to arrive.

In other aspects, the service requester application 175 determines, based on comparing the selected route to location changes of the service requester device 170, that the service requester 174 is following the route. The service requester application 175 can determine an ETA for the service requester 174 to an intermediate location between two legs of a multileg route and, when network connectivity is available, transmit a request to the network computer system 100 to arrange for a service provider 184 to fulfill the next leg of the route.

Once a service provider 184 is selected, the transportation coordination engine 130 can generate a service invitation to fulfill the service request for a given leg of the route and transmit the service invitation to the optimal service provider's device via the service provider application 185. In addition to the service invitation, the network computer system 100 can transmit requester information, such as a name and photograph of the service requester 174. Upon receiving the service invitation, the service provider 184 can either accept or reject the invitation. Rejection of the invitation can cause the transportation coordination engine 130 to determine another service provider from the candidate set of service providers 184 to fulfill the service request. However, if the service provider 184 accepts (e.g., via an acceptance input), then the acceptance input is transmitted back to the transportation coordination engine 130, which generates and transmits a confirmation of the service provider 184 to the service requester 174 via the service requester application 175 on the service requester device 170.

In various implementations, the network computer system 100 can store service requester profiles specific to the individual users of the on-demand service in the database 110. Such information can include user preferences of service types, routine routes, service start locations and service destinations, work addresses, home addresses, addresses of frequently visited locations (e.g., a gym, grocery store, mall, local airport, sports arena or stadium, concert venue, local parks, and the like). In addition, the network computer system 100 can store service provider profiles indicating information specific to individual providers and vehicles, such as vehicle type, license plate number, service qualifications, earnings data, and provider experience. The network computer system 100 can also include a database of historical data regarding service requester and service provider liquidity for a given area, which can include how often a new service provider 184 is expected to make themselves available for on-demand services in the area.

Computing Device

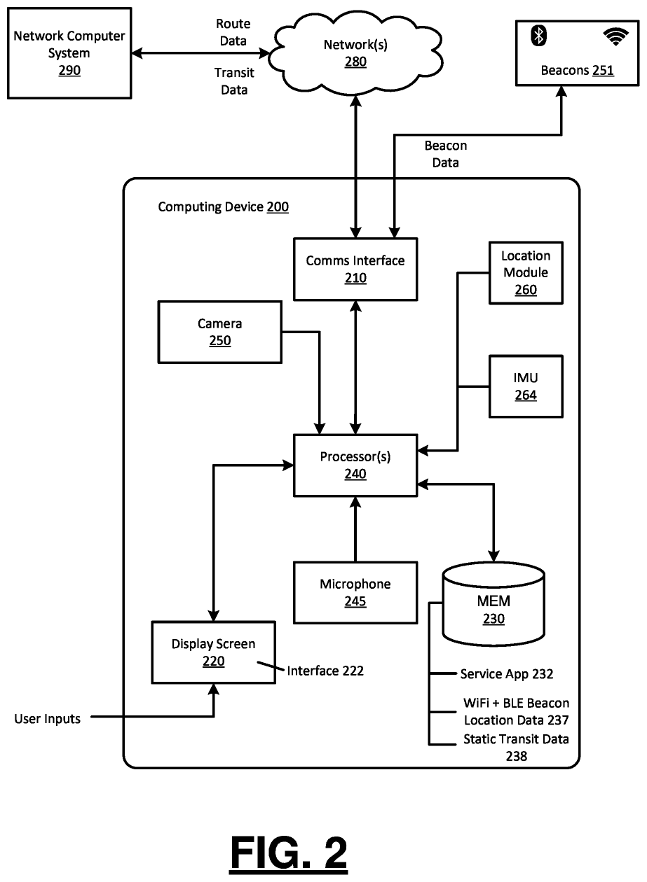

FIG. 2 is a block diagram illustrating an example computing device executing an application for communicating with a network computer system, according to examples described herein. In many implementations, the computing device 200 can comprise a mobile computing device, such as a smartphone, tablet computer, laptop computer, VR or AR headset device, and the like. As such, the computing device 200 can include telephony features such as a microphone 245, a camera 250, and a communication interface 210 to communicate with external entities using any number of wireless communication protocols.

The computing device 200 can further include a location module 260 and an inertial measurement unit 264 that includes one or more accelerometers, gyroscopes, or magnetometers. In certain aspects, the computing device 200 can store an on-demand service application 232 in a local memory 230. In variations, the memory 230 can store additional applications executable by one or more processors 240 of the computing device 200, enabling access and interaction with one or more host servers, including the network computer system 290, over one or more networks 280.

The computing device 200 can be operated by a user through execution of the on-demand service application 232. The user can select the service application 232 via a user input on the display screen 220, which can cause the service application 232 to be executed by the processor 240. In response, a user application interface 222 can be generated on the display screen 220, which can display available service options and enable the user to submit a request for transport.

As provided herein, the service application 232 can enable a communication link with a network computer system 290, such as the network computer system 100 as shown and described with respect to FIG. 1, over one or more networks 280. The processor 240 can generate user interface features using content data received from the network computer system 290 over the network 280. Furthermore, as discussed herein, the service application 232 can enable the network computer system 290 to cause the generated interface 222 to be displayed on the display screen 220.

In various examples, the location module 260 can provide data indicating the current geographic location of the computing device 200. The location module 260 can include a GPS unit to determine the location of the computing device 200 when a signal from GPS satellites is available. The location module 260 can also use signals received over the communications interface 210 from terrestrial sources, such as cellular towers and WiFi routers, to determine the location of the computing device 200 using techniques including triangulation.

In examples described herein, the network computer system 290 can transmit route data to the communication interface 210 of the computing device 200 over the network(s) 280. The route data can cause the executing service application 232 to display potential routes from a location to an input destination on the respective interface 222 for the service application 232. Upon selection of a desired route by a requesting user, the service application 232 can cause the processor 240 to transmit a transport request to the network computer system 290 to enable the network computer system 290 to coordinate with a transport provider to rendezvous with the user at a selected or determined rendezvous location.

Methodology

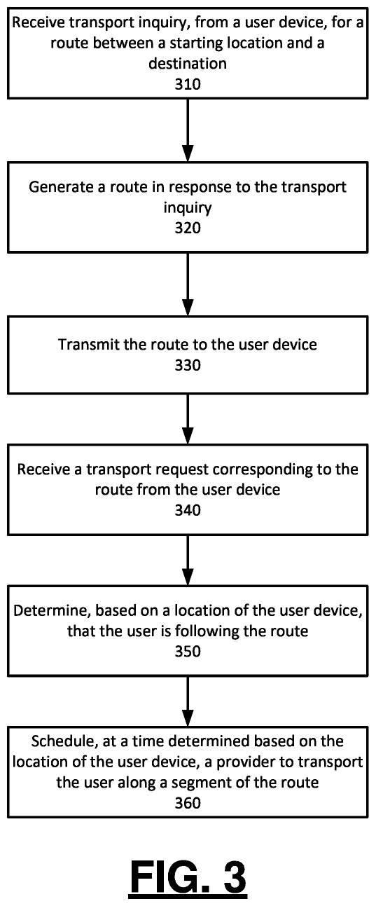

FIGS. 3, 4, and 5 illustrate methods for operating and interacting with a transit location system, according to some aspects. While operations of the methods are described below as being performed by specific components, modules or systems of the transit location system, it will be appreciated that these operations need not necessarily be performed by the specific components identified, and could be performed by a variety of components and modules, potentially distributed over a number of machines. Accordingly, references may be made to elements of the network computer system 100 or the computing device 200 for the purpose of illustrating suitable components or elements for performing a step or sub step being described. Alternatively, at least certain ones of the variety of components and modules described in the network computer system 100 and the computing device 200 can be arranged within a single hardware, software, or firmware component. It should also be appreciated that some of the steps of these methods may be performed in parallel or in a different order than illustrated.

FIG. 3 illustrates an example method for a network computer system to interact with a user device in the context of a transit location system.

In one aspect, the network computer system receives a transport inquiry from a user device for a route between a starting location and a destination (310). For example, when a user executes an on-demand service application on the user device and inputs a desired destination for a transportation service, the device can transmit the transport inquiry to the network computer system.

In one aspect, the network computer system generates a route in response to the transport inquiry (320). Depending on the distance between the starting location and the destination and available transportation options, the network computer system can generate a number of route options, some of which may be comprised of multiple legs using multiple modes of transportation, including public transit. For example, one route may involve a user taking a train from the user's current location to another train station where the user can take a ride-share vehicle to the destination.

In one aspect, the network computer system transmits the route or route options to the user device (330). The user can select one of the route options and view instructions showing when and where to catch various methods of transit (e.g., trains, buses) to reach the destination.

Once the user selects one of the route options through the user device, the user device generates a transport request corresponding to the selected route. The network computer system receives the transport request corresponding to the route from the user device (340). In situations where the first leg of the route uses a ride-share vehicle, the network computer system can schedule a service provider to rendezvous with the user. In situations where the first leg of the route involves transit, the network computer system can monitor the user device to determine whether the user is following the route and then schedule service providers as necessary for later legs of the route.

In one aspect, the network computer system determines, based on a location of the user device, that the user is following the route (350). The network computer system can use the transit data to determine whether the user is following the route by, for example, comparing the geographic location over time of the user device with schedules and locations of transit vehicles that the user is expected to use when following the route. In addition or as an alternative, the user device can determine whether the user is following the route and transmit the determination to the network computer system.

Upon determining that the user is following the route and at a time determined based on the location of the user device, the network computer system schedules a provider to transport the user along the next leg of the route (360).

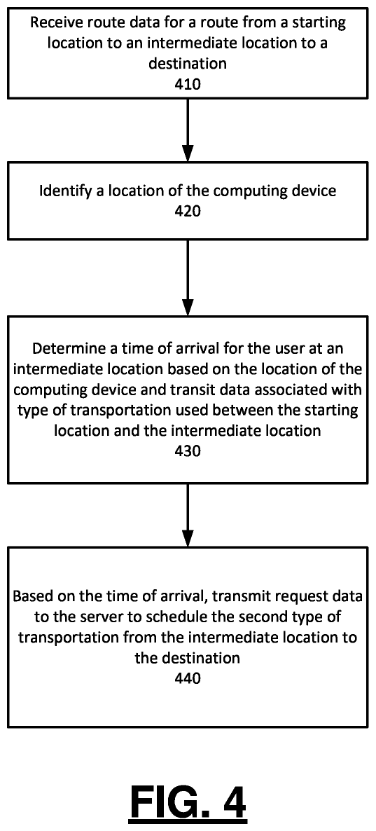

FIG. 4 illustrates an example method for a user's mobile computing device to request transport from a transit location system.

In one aspect, the user's mobile computing device receives route data for a route from a starting location to an intermediate location to a destination (410). For example, the route data can correspond to a transport request submitted by the user for transport from the starting location to the destination. The route data can include multiple legs across multiple modes of transportation, such as taking a train from the starting location to the intermediate location and then taking a ride-share vehicle from the intermediate location to the destination.

In order to determine whether the user is following the route, the user's mobile computing device identifies a location of the computing device (420). This can be performed periodically, and based on a pattern of location data points over time, the computing device can determine whether the user is following the route and where the user is at along the route. In some implementations, the computing device can also use transit data to determine whether the user is following the route by, for example, comparing the geographic location over time of the computing device with schedules and locations of transit vehicles that the user is expected to use when following the route.

In one aspect, the user's mobile computing device determines a time of arrival for the user at the intermediate location based on the location of the computing device and the transit data associated with type of transportation used between the starting location and the intermediate location (430). For example, if the user is taking a bus from the starting location to the intermediate location, the time of arrival can be based on the bus schedule for the bus that the user is riding, with any adjustments for the arrival time made using real-time transit data.

In one aspect, based on the time of arrival, the user's mobile computing device transmits request data to the server to schedule the second type of transportation from the intermediate location to the destination (440). For example, when the user's mobile computing device determines that the user should arrive within a threshold period of time (e.g., 5 minutes, or a time determined based on supply and demand in the area) at the intermediate location to rendezvous with a driver of a ride-share vehicle for the next leg of the route, the device can transit a transport request for the next leg of the route.

In some aspects, the service requester application and/or the network computer system can search the area around the user's selected destination for appropriate pickup or drop-off points. Accordingly, the destination of the data corresponding to the route from the first location to the destination may be a programmatically determined destination rather than the actual spot or address that the user inputted. For example, the destination can be selected from a database of verified pickup/drop-off locations or can be selected through the use of an algorithm that processes map data to determine appropriate pickup/drop-off locations.

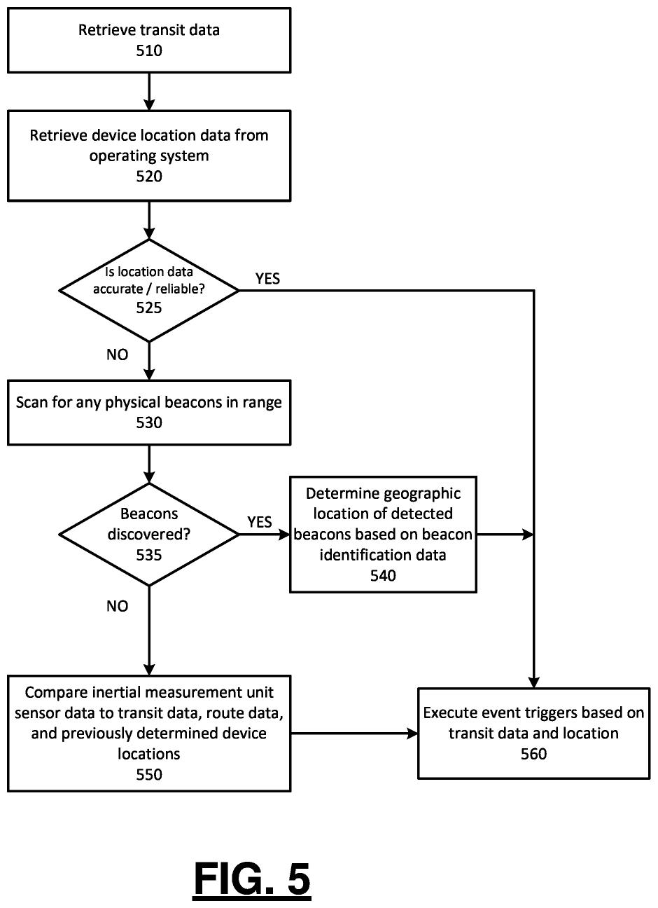

FIG. 5 illustrates an example method for a user device to determine its location in the context of an example transit location system. In this example, the user device can refer to one of the service requester devices as illustrated in FIG. 1. Thus, the user device can comprise a mobile computing device, such as a smartphone or tablet computer, with functionality to execute a designated service requester application corresponding to the on-demand arrangement service managed by the network computer system 100.

In some aspects, users can request a route from a starting location to a destination and receive a list of options. The user can select one of the route options and view instructions showing when and where to catch various methods of transit (e.g., trains, buses) to reach the destination. In order to determine whether the user is following the route, the user device can periodically determine its location through methods such as GPS and cellular triangulation. Based on the location, the user device can provide status updates and other information to the network computer system and the user. However, these methods are generally ineffective underground. On a subway or underground train with unreliable cellular coverage and no view of the sky, the user device cannot rely on traditional methods to determine its location to verify whether the user is following the selected route. To solve this problem, the service requester application can utilize alternate sources of data for fallback or supplementary location-determination functionality.

In some aspects, the user device can utilize transit data in order to perform some functions as part of a transit location system, such as determining the location of the user device underground and enabling a user to make transport requests that include public transit options. The transit data can include information for various transit systems utilizing transportation vehicles such as trains, buses, subways, and others. At least some of the transit data can conform to the General Transit Feed Specification (GTFS), which is a data specification that allows transit agencies to publish their transit data in a format that can be consumed by software applications such as the service requester application. GTFS is split into a static component that contains arrival and departure schedules, fare, geographic transit information, etc. and a real-time or live component that contains arrival predictions, timestamped geographic location data of vehicles, service advisories, etc. The transit data can include geographic location data in the form of latitude and longitude coordinates for stations (or stops) and can also include timing information in the form of arrival times, departure times, dates for vehicles (i.e., trains, buses) at each of the stations.

In some aspects, the service requester application downloads and stores the static transit data on the user device, either as part of software updates or in response to manual or programmatic triggers. Then, when needed, the user device can retrieve the static transit data from a storage location associated with the service requester application on the user device (510). The user device can retrieve live transit data in response to a request from a user, such as a request for a route that includes transit options. The user device can additionally or alternatively retrieve live transit data on a periodic basis when the service requester application is being executed so that live transit data is available even if the user device does not have network connectivity when the user accesses a function of the service requester application that makes use of live transit data. The service requester application can download the transit data from the network computer system or directly from one or more transit data providers.

In some aspects, the user device can attempt to determine its location through the device operating system's location feature, which may utilize GPS and/or cellular connectivity (520). The operating system can return (e.g., through a location application program interface (API)) the last known location of the user device, which may be in the form of latitude and longitude coordinates.

The service requester application can determine whether the location data provided by the operating system is accurate and reliable, and if so, use that location data (525). One indicator of accuracy and reliability can include whether the operating system returns actual coordinates or a null value, which may occur if the user has turned off location services. The service requester application can also determine whether the last known device location has changed or remained fixed for a period of time (i.e., a period of time exceeding a programmed threshold freshness value), which may indicate that the operating system has been unable to determine a new location for the device due to being out of contact with cellular towers and GPS satellites. The service requester application can also plot the location coordinates on a map and perform a sanity check to determine whether the location data is reliable.

If the service requester application determines that the location data received from the device operating system is unreliable, which is often the case when the user is underground, the user device can scan for wireless beacons, such as WiFi routers and beacons using Bluetooth Low Energy (BLE), to use for localization (530). In some implementations, the user device can scan for wireless beacons even if the location data from the operating system is not deemed unreliable in order to supplement or check the location data for accuracy.

If the user device discovers any wireless beacons within its scanning range, the user device can receive any broadcast beacon identification data, which can include Media Access Control (MAC) addresses and/or Service IDs (535). For each detected WiFi router and BLE beacon, the user device can attempt to determine the geographic location of the wireless beacon.

In some aspects, the user device determines the geographic location of a wireless beacon based on the beacon identification data (540). For example, the user device can cross-reference the MAC address and/or Service ID of the device with a known beacon location database, which can be stored on the user device. The database can contain associated latitude and longitude coordinates of MAC addresses and Service IDs of wireless beacons. In one implementation, the service requester application also has access to a database of transit station coordinates, and the service requester application cross-references the location of the wireless beacon with the transit stations in order to determine a current transit station that the user is located in. Alternatively or in addition, the known beacon location database can include station data identifying which transit station the beacon is located in. In some variations, the user device can receive location information directly from wireless beacons that support such a feature.

In further aspects, the user device can use inertial sensors, such as an accelerometer, to detect that the user is on a train (or other means of transportation), when the train arrives and leaves a station, and how many stations the user has passed through on the train. For example, the service requester application can include various acceleration profiles of trains and compare the profiles to data generated by the user device inertial sensors in order to determine, within a programmed certainty threshold, that the user is leaving a station on a train or arriving at a station on a train. These calculations can be used to compare a selected route within the service requester application to transit routes in the retrieved transit data in order to determine the location of the user device (550).

In addition or alternatively, any previously determined locations of the user device can assist in determining where the user is along the route when cross-referenced with static transit data. For example, assume the static transit data indicates that the user's route passes through a first station then is scheduled to arrive at a second station five minutes later. If the user device determined its location at the first station, and five minutes later the device's inertial sensor data indicates that the user is on a train that has arrived at a station, the user device can determine that the user is located at the second station. In some aspects, the user device can determine its location through the use of live transit data. For example, the user device may be able to connect to the internet or a local network and access live transit data indicating a train arrival at a station at a time that corresponds to inertial sensor data indicating the user device being on a train arriving at the station.

In some aspects, the user device can create various service-related triggers with associated location and timing criteria. These triggers can include alerts or push notifications to the user as well as automatically performing functions of the service requester application. Based on a comparison of the selected route with the determined location, any previously-determined locations, and/or the transit data, the service requester application can determine whether the user is following the selected route, where the user is on that route, when the user should arrive at certain points along the route, etc.

The service requester application can then execute any triggers that satisfy the location and timing criteria (560). In some examples, the user device can provide guided navigation to the user, including text or voice route notifications to inform the user to get on or off a specific train at the correct time as part of the selected route. In other examples, the transit location system can provide information to the user about any delays or transit congestion along the selected route.

In multimodal transit scenarios, one trigger can include scheduling the next mode of transportation for the user at an appropriate time based on an estimated time of arrival. For example, if the user device determines that the user is on a train heading towards Station D and the next leg of the user's selected multimodal route involves taking a rideshare vehicle from Station D, the user device can automatically transmit a transport request to the network computer system to solicit a vehicle to take the user from Station D to the next point on the user's route. The transport request can be sent when the user device detects network connectivity.

### Example

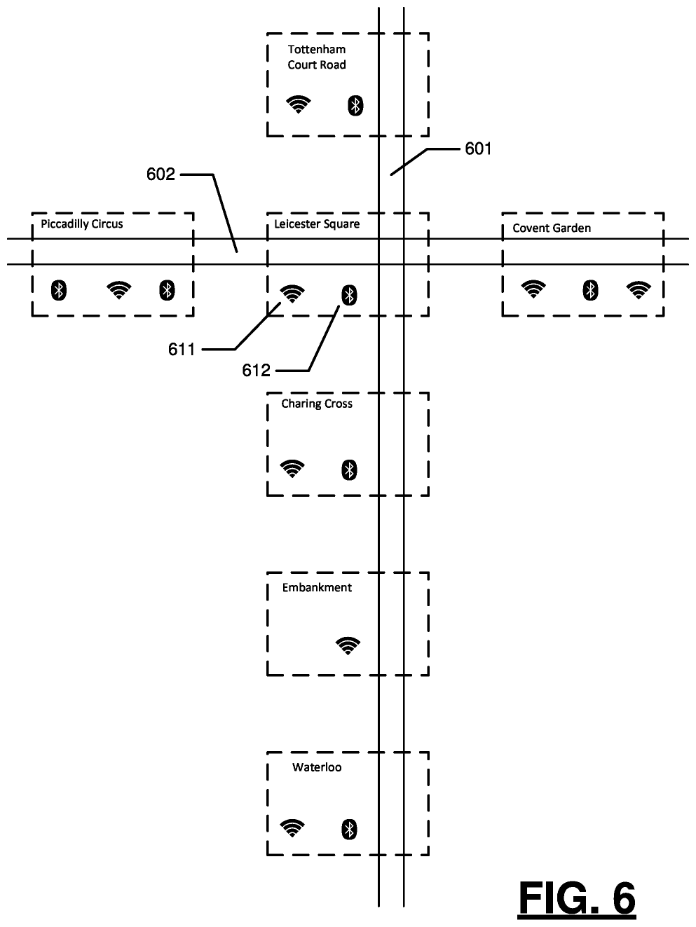

FIG. 6 is a simplified map depicting transit stations as part of a use case example. As shown, each of the underground subway stations has one or more hardware transmitter beacons, such as WiFi routers 611 and Bluetooth Low Energy (BLE) beacons 612, that a user device can use to determine its location underground.

In one example, a user near the Leicester Square station executes a service requester application on a user device and inputs a desired transport destination in another part of London. The service requester application determines the current location of the user through traditional methods, such as GPS and cellular triangulation, if possible. If the user is underground or the traditional methods fail for other reasons, the user device can receive broadcasts from any nearby beacons and determine location based on the received data. For example, the user device receives a broadcasted Service ID from a BLE beacon 612 at Leicester Square, and the service requester application looks up the Service ID in a database to determine that the BLE beacon 612 is associated with Leicester Square station. Therefore, the service requester application determines that the user is also located at Leicester Square.

With the current location of the device known, the application requests a route, from the current location to the user's input destination, from a network computer system-based on-demand transport service. Based on transit data, traffic data, and other considerations, the network computer system generates and transmits a multileg, multimodal route that includes a first leg taking transit and a second leg taking a ride-share vehicle. The first leg involves the user taking the north-south train line 601 to Waterloo station, and the second leg involves the user taking a ride-share vehicle from a surface street near Waterloo station to the final destination.

The user accepts the proposed route on the interface of the application, which sends a transport request to the network computer system. The application displays instructions to the user to board the north-south train line 601 at Leicester Square. As the user device remains underground, its location may not update until it receives a broadcast signal from a beacon at Charing Cross. Based on the beacon data, the application determines that the user has reached Charing Cross station. By referencing static schedules and/or real-time transit data for the north-south train line 601, the application can compare the expected times for the route with the current time to determine whether the user is following the route (and not on east-west train line 602 by mistake, for example). In situations where a discrepancy is detected, the application can adjust the route as necessary, which may involve transmitting a notice to the network computer system and receiving an updated route.

In this example, the user continues riding the subway to Embankment station. However, the device may not be able to identify its location from the WiFi router at Embankment station, which can occur for reasons such as being out of range, MAC address randomization for the router, or the router not being in the database.

In one aspect, the user device can use inertial sensors, such as an accelerometer, to detect that the user was still on the train and that the train has arrived at the next station. For example, the application can include various acceleration profiles of trains and compare the profiles to data generated by the user device inertial sensors in order to determine, within a programmed certainty threshold, that the user has arrived at the next station. Based on a comparison of the route data to transit routes in transit data within the application, the application can determine that the user has arrived at Embankment station.

In one variation, upon determining that the user is still following the route and the user should reach the intermediate point between legs of the route within a threshold period of time, the application transmits a request or status update to the network computer system, assuming the user device has internet connectivity (e.g., through the WiFi router at Embankment station). In another variation, the user device transmits its location to the network computer system, and the network computer system determines that the user is still following the route and the user should reach the intermediate point between legs of the route within the threshold period of time. The network computer system can begin searching for suitable drivers, based on estimated times of arrival for the user and any available drivers in the vicinity, to fulfill the second leg of the route and transport the user from a point near Waterloo station to the user's destination. Upon matching the user with a suitable driver and determining that the user device currently has network connectivity, the network computer system can transmit the driver information to the user device.

Once the user reaches Waterloo station, the application determines the device location from cellular/GPS signals, nearby beacons, or inertial measurements as necessary. The application compares the location to the route and generates a push notification to display an alert on the application interface instructing the user to exit the subway. The application displays information pertaining to the next leg of the route, such as where the user should meet the driver of the ride-share vehicle, a name and photograph of the driver, etc. The application can also display a map with walking directions to the rendezvous point, among other information.

Computer System

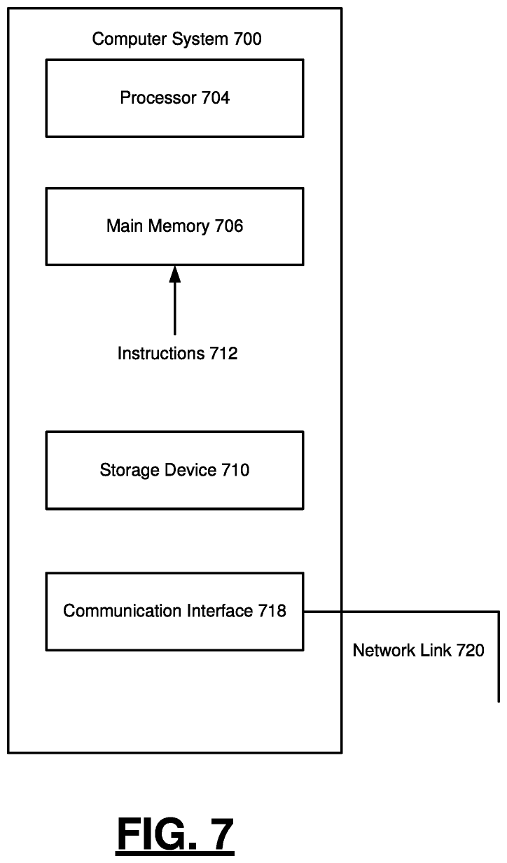

FIG. 7 is a block diagram that illustrates a computer system upon which aspects described herein may be implemented. For example, in the context of FIG. 1, the network computer system 100 may be implemented using one or more servers such as described by FIG. 7.

In an aspect, the computer system 700 includes a processor 704, memory 706 (including non-transitory memory), a storage device 710, and a communication interface 718. The computer system 700 includes at least one processor 704 for processing information. The computer system 700 also includes the main memory 706, such as a random access memory (RAM) or other dynamic storage device, for storing information and instructions to be executed by the processor 704. Main memory 706 also may be used for storing temporary variables or other intermediate information during execution of instructions to be executed by processor 704. The computer system 700 may also include a read only memory (ROM) or other static storage device for storing static information and instructions for the processor 704. The storage device 710, such as a magnetic disk or optical disk, is provided for storing information and instructions. The communication interface 718 may enable the computer system 700 to communicate with one or more networks through use of the network link 720 and any one of a number of well-known transfer protocols (e.g., Hypertext Transfer Protocol (HTTP)). Examples of networks include a local area network (LAN), a wide area network (WAN), the Internet, mobile telephone networks, Plain Old Telephone Service (POTS) networks, and wireless data networks (e.g., WiFi and Wi-Max networks).

Examples described herein are related to the use of the computer system 700 for implementing the techniques described herein. According to one aspect, those techniques are performed by computer system 700 in response to the processor 704 executing one or more sequences of one or more instructions contained in main memory 706. Such instructions may be read into main memory 706 from another machine-readable medium, such as the storage device 710. Execution of the sequences of instructions contained in main memory 706 causes the processor 704 to perform the process steps described herein. In alternative aspects, hard-wired circuitry may be used in place of or in combination with software instructions to implement aspects described herein. Thus, aspects described are not limited to any specific combination of hardware circuitry and software.

Although illustrative aspects have been described in detail herein with reference to the accompanying drawings, variations to specific examples and details are encompassed by this disclosure. It is intended that the scope of examples described herein be defined by claims and their equivalents. Furthermore, it is contemplated that a particular feature described, either individually or as part of an aspect, can be combined with other individually described features, or parts of other aspects. Thus, absence of describing combinations should not preclude the inventor(s) from claiming rights to such combinations.

What is claimed is:

1. A computing device, the computing device comprising:
one or more processors; and
a memory storing instructions that, when executed by the one or more processors, cause the computing device to:
receive data, from a server over one or more networks, corresponding to a route from a first location to a destination, the route including at least a first leg to an intermediate location using a first type of transportation and a second leg from the intermediate location to the destination using a second type of transportation;
identify a location of the computing device;
determine a time of arrival for a user of the computing device at the intermediate location based on the location of the computing device and transit data associated with the first type of transportation; and
based on the time of arrival, transmit request data to the server to schedule the second type of transportation from the intermediate location to the destination.

2. The computing device of claim 1, further comprising instructions that, when executed by the one or more processors, cause the computing device to:
receive the transit data associated with the first type of transportation;
store the transit data on the computing device; and
use the stored transit data to identify the location of the computing device.

3. The computing device of claim 1, further comprising instructions that, when executed by the one or more processors, cause the computing device to:
receive input from the user of the computing device; and
determine the destination based on the received input.

4. The computing device of claim 1, further comprising instructions that, when executed by the one or more processors, cause the computing device to:
transmit, to the server, a transport request from the user of the computing device from the first location to the destination.

5. The computing device of claim 1, wherein the transit data includes arrival schedules and departure schedules.

6. The computing device of claim 1, wherein the transit data includes timestamped geographic location data for transportation vehicles.

7. The computing device of claim 1, further comprising instructions that, when executed by the one or more processors, cause the computing device to:
based on comparing the location of the computing device, the transit data, and the route, provide the user of the computing device with a route notification.

8. The computing device of claim 7, wherein the route notification includes directing the user to board or exit a transportation vehicle.

9. A non-transitory computer readable medium storing instructions that, when executed by one or more processors of a computing device, cause the one or more processors to:
receive data, from a server over one or more networks, corresponding to a route from a first location to a destination, the route including at least a first leg to an intermediate location using a first type of transportation and a second leg from the intermediate location to the destination using a second type of transportation;
identify a location of the computing device;
determine a time of arrival for a user of the computing device at the intermediate location based on the location of the computing device and transit data associated with the first type of transportation; and
based on the time of arrival, transmit request data to the server to schedule the second type of transportation from the intermediate location to the destination.

10. The non-transitory computer readable medium of claim 9, further comprising instructions that, when executed by the one or more processors, cause the computing device to:
receive the transit data associated with the first type of transportation;
store the transit data on the computing device; and
use the stored transit data to identify the location of the computing device.

11. The non-transitory computer readable medium of claim 9, further comprising instructions that, when executed by the one or more processors, cause the computing device to:
receive input from the user of the computing device; and
determine the destination based on the received input.

12. The non-transitory computer readable medium of claim 9, further comprising instructions that, when executed by the one or more processors, cause the computing device to:
transmit, to the server, a transport request from the user of the computing device from the first location to the destination.

13. The non-transitory computer readable medium of claim 9, wherein the transit data includes arrival schedules and departure schedules.

14. The non-transitory computer readable medium of claim 9, wherein the transit data includes timestamped geographic location data for transportation vehicles.

15. The non-transitory computer readable medium of claim 9, further comprising instructions that, when executed by the one or more processors, cause the computing device to:
based on comparing the location of the computing device, the transit data, and the route, provide the user of the computing device with a route notification.

16. The non-transitory computer readable medium of claim 15, wherein the route notification includes directing the user to board or exit a transportation vehicle.

17. A network computer system for managing a network-based service, the network computer system comprising:
one or more processors; and
one or more memory resources storing instructions that, when executed by the one or more processors, cause the network computer system to:
receive a transport request, from a user device over one or more networks, for a route from a first location to a destination, the route including at least a first leg to an intermediate location using a first type of transportation and a second leg from the intermediate location to the destination using a second type of transportation;
receive transit data associated with the first type of transportation;
determine, based on a location of the user device and the transit data, that a user of the user device is following the route; and
schedule, at a time determined based on the location of the user device, a provider to transport the user along the second leg of the route.

18. The network computer system of claim 17, wherein determining that the user is following the route includes comparing the location of the user device at a first time to the transit data to determine the user was on a transportation vehicle of the first type of transportation at the first time.

19. The network computer system of claim 17, wherein the transit data includes arrival schedules and departure schedules.

20. The network computer system of claim 17, wherein the transit data includes timestamped geographic location data for transportation vehicles.
